(19) United States
(12) Patent Application Publication
(10) Pub. No.: US 2004/0227979 A1
(43) Pub. Date: Nov. 18, 2004

(54) Image access device with a wireless transmission function

(76) Inventor: Yen-Cheng Chen, Hsinchu (TW)

Correspondence Address: RABIN & Berdo, PC, 1101 14TH STREET, NW, SUITE 500, WASHINGTON, DC, 20005, US

(21) Appl. No.: 10/720,070

(22) Filed: Nov. 25, 2003

(30) Foreign Application Priority Data
May 14, 2003 (TW) 92113141

(51) Int. Cl. H04N 1/04; H04B 7/00

(52) U.S. Cl. 358/474; 455/41.3

(57) ABSTRACT

An image access device with a wireless transmission function is provided. The image device includes a scan unit, a wireless scan operation unit, a control unit and a first wireless transmission unit is provided. The scan unit is used for scanning a document to be scanned and outputting a scan image accordingly. The wireless scan operation unit is used for being triggered off to output a signal which initiates wireless scan function accordingly. The control unit is used for receiving the signal which initiates the wireless scan function to control the scan unit to scan the document to be scanned accordingly. The first wireless transmission unit is used for receiving the scan image and transmitting the scan image to a portable electronic device in a wireless transmission way.

This application claims the benefit of Taiwan application Serial No. 92113141, filed May 14, 2003.

### BACKGROUND OF THE INVENTION

1. Field of the Invention

The invention relates in general to an image access device, and more particularly to an image access device which can transmit at least a scan image to a portable electronic device in a wireless transmission way.

2. Description of the Related Art

With the rapid advance in science and technology, the integration and application of multi-media have become an important trend nowadays. Multi-media are data contents comprising texts, images, voices and other data types. Several multi-media devices which can access images or voices have already been developed allowing stored data to be presented via multi-media. In terms of image processing, the scanner is one of most commonly used image access devices.

Referring to FIG. 1, a block diagram for the handy wireless transmission controller which can control a scanner and is disclosed in Taiwanese Patent Publication No. 517479. In FIG. 1, the user can use handy wireless transmission controller 120, e.g., a personal digital assistant (PDA), to control scanner 102 which is equipped with first wireless transmission module 104 so that scanner 102 can scan a to-be-scanned document and generate a corresponding scan image. Handy wireless transmission controller 120 comprises second wireless transmission module 122, data storage device 124, editing and trigger device 126, wherein data storage device 124 is used for storing plural data items and plural sets of operation commands the user pre-sets on scanner 102. Of which, the pre-set data items can be settings of resolution and scan area, while these operation commands can be, for instance, scan execution command and image transmission command.

Editing and trigger device 126 is coupled to data storage device 124, availing the user to operate and edit the pre-set data and operation commands stored in data storage device 124. Moreover, editing and trigger device 124 can be triggered off by the user so that data storage device 124 will output corresponding operation commands. Second wireless transmission module 122 is coupled to data storage device 124 and is able to wirelessly communicate with first wireless transmission module 104. However, first wireless transmission module 104 and second wireless transmission module 106 are equipped with the same wireless transmission protocol, such as infrared wireless transmission protocol or Bluetooth wireless transmission protocol. Second wireless transmission module 122 wirelessly transmits the pre-set data and the operation commands triggered by the user to first wireless transmission module 104. After first wireless transmission module 104 has received the pre-set data and the operation commands triggered off by the user, scanner 102 will execute the operation commands triggered off by the user according to the scan environment defined by the pre-set data. Furthermore, scanner 102 can wirelessly transmit scan images to handy wireless transmission controller 120 or other handy wireless transmission controllers.

It is noteworthy that handy wireless transmission controller 120 must be equipped with a driver corresponding to scanner 120, allowing the user to have a remote control of scanner 102 via handy wireless transmission controller 120 for the purpose of scan settings and operation, e.g., printing resolution and scan area.

The driver of the portable electronic product, especially handy electronic products, a personal digital assistant (PDA) for instance, may differ from one manufacturer to another and it is not practical to have an extra driver design for individual scanner manufacturer. In other words, in terms of compactness between a PDA and a scanner of different makes, the technical issues involved are very complicated for plural PDA's to control the same scanner or for the same PDA to control plural scanners. Moreover, it is not possible for all PDA's to be equipped with data storage device 124 in which the pre-set data items and the operation commands corresponding to scanner 102 can be stored, allowing the PDA to control scanner 102. Normally, the user controls a scanner directly or via a computer, not via a convenient and handy portable electronic product. Hence the PDA which can be used as handy wireless transmission controller 120 of scanner 102 is extremely rare. Even the PDA which has already gained a great popularity still lacks such application. In terms of practical use, handy wireless transmission controller 120 disclosed in Taiwanese Patent Publication No. 517479 can not be widely used and has very low applicability.

### SUMMARY OF THE INVENTION

It is therefore an object of the invention to provide an image access device with a wireless transmission function, which, after receiving a wireless scan function initiating signal, scans a to-be-scanned document and wirelessly transmits the produced scan image to a portable electronic device, allowing the user to have a handy access of scan image via a portable electronic device.

It is another object of the invention to provide an image access device with a wireless transmission function comprising a scan unit, a control unit and a first wireless transmission unit. The scan unit is used for scanning a document to be scanned and outputting a scan image accordingly. The control unit is used for receiving a signal which initiates the wireless scan function initiating signal to control the scan unit to scan the to-be-scanned document accordingly. The first wireless transmission unit is used for receiving this scan image and transmitting the scan image to a portable electronic device in a wireless transmission way.

It is another object of the invention to provide an image access device with a wireless transmission function comprising a scan unit, a wireless scan operation unit, a control unit and a first wireless transmission unit. The scan unit is used for scanning a to-be-scanned document and outputting a scan image accordingly. The wireless scan operation unit is used for being triggered off to output a signal which initiates wireless scan function accordingly. The control unit is used for receiving the signal which initiates the wireless scan function to control the scan unit to scan the document to be scanned accordingly. The first wireless transmission unit is used for receiving this scan image and transmitting the scan image to a portable electronic device in a wireless transmission way.

It is another object of the invention to provide an image access device with a wireless transmission function comprising a scan unit, a control unit and a first wireless transmission unit. The scan unit is used for scanning a document and outputting a scan image accordingly. The control unit is used for receiving a signal which initiates the wireless scan function initiating signal output by a computer to control the scan unit to scan the document to be scanned accordingly. The first wireless transmission unit is used for receiving this scan image and transmitting the scan image to a portable electronic device in a wireless transmission way.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of the handy wireless transmission controller which can control a scanner and is disclosed in Taiwanese Patent Publication No. 517479;

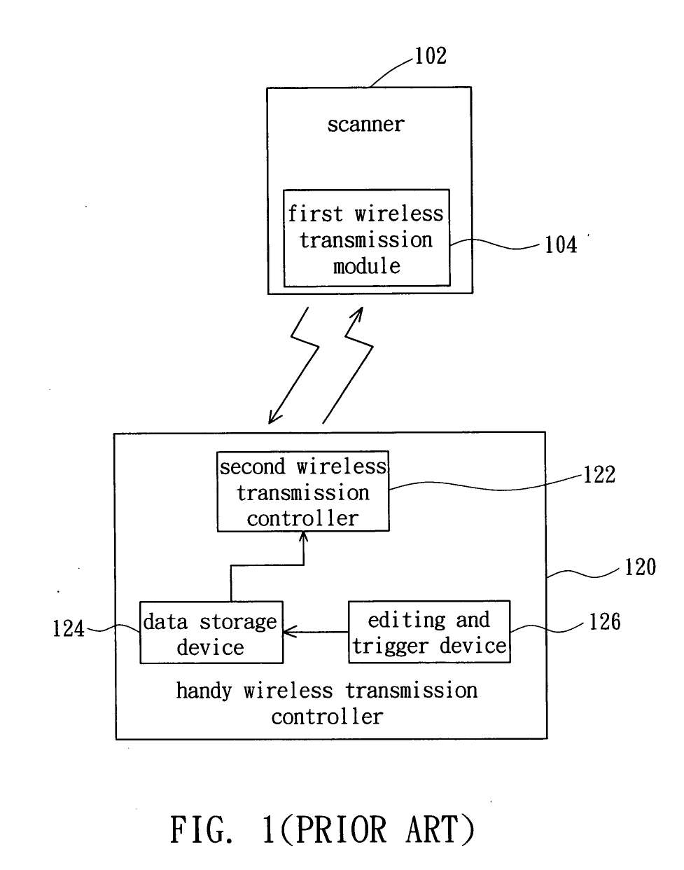

FIG. 2 shows block diagrams of an image access device with a wireless transmission function and a portable electronic device according to preferred embodiment one of the invention;

FIG. 3 shows block diagrams of an image access device with a wireless transmission function, a computer and a portable electronic device according to preferred embodiment two of the invention.

### DETAILED DESCRIPTION OF THE INVENTION

An image access device with a wireless transmission function is particularly designed according to the object of the invention. After receiving a signal which initiates the wireless scan function, the image access device scans a to-be-scanned document and transmits a produced scan image to a portable electronic device in a wireless transmission way, allowing the user to have a handy access of the scan image via the portable electronic device. The practical application of the image access device according to the invention is disclosed in preferred embodiment one and preferred embodiment two accompanied by diagrams and explanations.

### Preferred Embodiment One

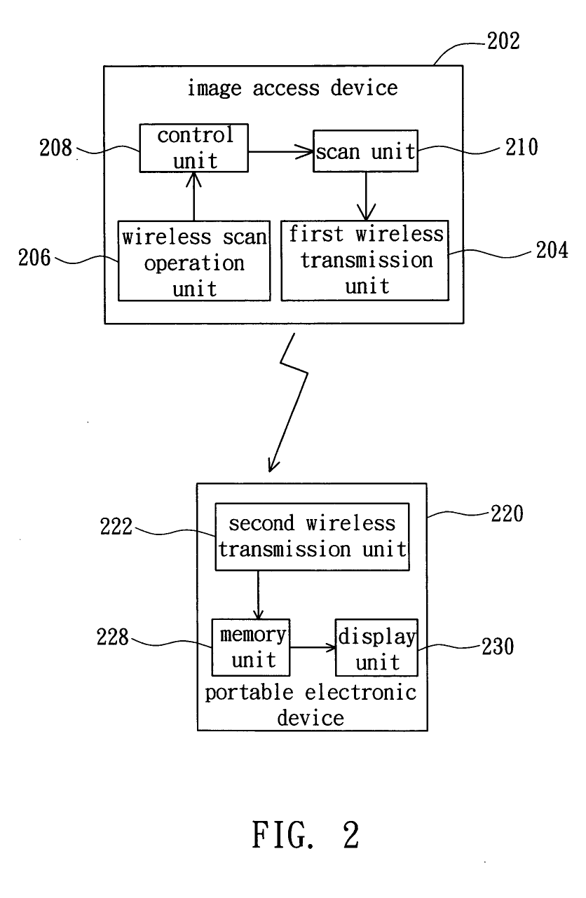

Referring to FIG. 2, block diagrams of an image access device with a wireless transmission function and a portable electronic device according to preferred embodiment one of the invention. In FIG. 2, image access device 202 comprises first wireless transmission unit 204, wireless scan operation unit 206, control unit 208 and scan unit 210. Scan unit 210 is used for scanning a to-be-scanned document (not shown in FIG. 2) and outputting a scan image accordingly. Wireless scan operation unit 206 is used for being triggered off by the user to output a signal, which initiates the wireless scan function accordingly. Besides, wireless scan operation unit 206 can be a touch panel or a hot key; either of which facilitates the user to initiate the wireless scan function. Control unit 208, which is coupled to scan unit 210 and wireless scan operation unit 206, is used for receiving the signal which initiates the wireless scan function whereby control unit 208 controls scan unit 210 to scan the document to be scanned and outputs the scan image accordingly. First wireless transmission unit 204, which is coupled to scan unit 210, is used for receiving the scan image output by scan unit 210 and transmitting a produced scan image to portable electronic device 220 in a wireless transmission way.

Portable electronic device 220 comprises second wireless transmission unit 222, memory unit 228 and display unit 230. Second wireless transmission unit 222, which is equipped with a wireless transmission protocol compatible with or the same with that of first wireless transmission unit 204, is used for receiving the scan image. Memory unit 228, which is coupled to second wireless transmission unit 222, is used for storing the scan image received by second wireless transmission unit 222. Display unit 230, which is coupled to memory unit 228, is used for displaying the scan image stored in memory unit 228 for the user.

If a user would like to have a handy access of the scan image of the document to be scanned, he or she can, first of all, place portable electronic device 220 close to image access device 202 and trigger off wireless scan operation unit 206 which will output a signal, which initiates the wireless scan function, to control unit 208. On receiving the signal, control unit 208 will control scan unit 210 to scan the to-be-scanned document accordingly. Scan unit 210 will output the scan image to first wireless transmission unit 204. After that, first wireless transmission unit 204 will transmit the scan image to second wireless transmission unit 222 of portable electronic device 220 in wireless transmission way. After having been received by second wireless transmission unit 222, the scan image will be stored in memory unit 228. Hence, the user can have a handy access of the scan image of the to-be-scanned document with them by means of portable electronic device 220.

### Preferred Embodiment Two

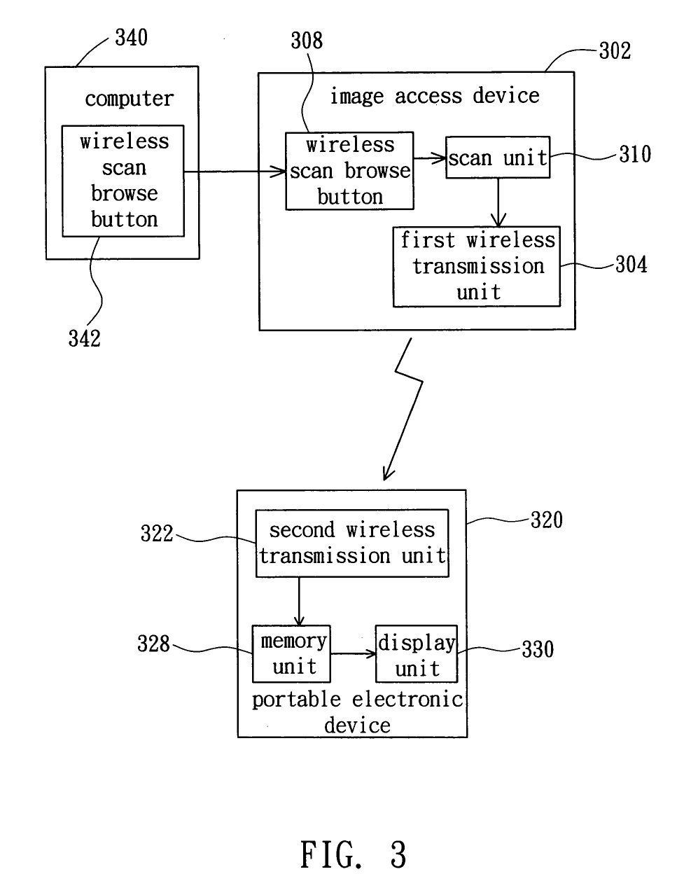

Referring to FIG. 3, block diagrams of an image access device with a wireless transmission function, a computer and a portable electronic device according to preferred embodiment two of the invention. In FIG. 3, image access device 302 is coupled to computer 340 which is equipped with wireless scan browse button 342 which is displayed on the monitor screen of computer 340 (not shown in FIG. 3) for the user to click and select so that computer 340 outputs a signal, which initiates the wireless scan function, to image access device 302 accordingly.

Image access device 302 comprises first wireless transmission unit 304, wireless scan operation unit 306, control unit 308 and scan unit 310. Scan unit 310 is used for scanning a to-be-scanned document (not shown in FIG. 3) and outputting a scan image accordingly. Control unit 308, which is coupled to scan unit 310 and computer 340, is used for receiving the signal, which initiates the wireless scan function, output by computer 340, whereby the control unit 308 controls scan unit 310 to scan the to-be-scanned document and outputs the scan image accordingly. First wireless transmission unit 304, which is coupled to scan unit 310, is used for receiving the scan image output by scan unit 310 and transmitting a produced scan image to portable electronic device 320 in a wireless transmission way.

Portable electronic device 320 comprises second wireless transmission unit 322, memory unit 328 and display unit 330. Second wireless transmission unit 322, which is equipped with a wireless transmission protocol compatible with or the same with that of first wireless transmission unit 304, is used for receiving scan images. Memory unit 328, which is coupled to second wireless transmission unit 322, is used for storing the scan image received by second wireless transmission unit 322. Display unit 330, which is coupled to memory unit 328, is used for displaying the scan image stored in memory unit 328 for the user.

If a user would like to have a handy access of the scan image of the to-be-scanned document, he or she can, first of all, place portable electronic device 320 close to image access device 302 and trigger off wireless scan browse button 342 of computer 340 which will output a signal, which initiates the wireless scan function, to control unit 308. On receiving the wireless scan function initiating signal, control unit 308 will command scan unit 310 to scan the to-be-scanned document. Scan unit 310 will output the scan image to first wireless transmission unit 304. After that, first wireless transmission unit 304 will transmit the scan image to second wireless transmission unit 322 of portable electronic device 220 in wireless transmission way. After having been received by second wireless transmission unit 322, the scan image will be stored in memory unit 328. Hence, the user can have a handy access of the scan image of the to-be-scanned document with him or her by means of portable electronic device 320.

Anyone who is familiar with the above-disclosed technology should realize that the technology of the invention is not limited thereto. For example, in the above two preferred embodiments, the wireless transmission protocol for the first wireless transmission unit and the second wireless transmission unit can be 802.11a, 802.11b, 802.11g or Bluetooth wireless transmission protocol. Of which, the first wireless transmission unit has a wireless transmission range within which the second wireless transmission unit must be located in order to be able to receive the scan image output by the first wireless transmission unit. Moreover, the portable electronic device can be a handy electronic product such as a PDA or a mobile phone. The image access device according to the invention can be a scanner while the scan unit can be a chassis.

The image access device with a wireless transmission function according to the invention disclosed in the above preferred embodiments scans a to-be-scanned document and transmits the produced scan image to a portable electronic device via which the user can have a handy access of the scan image which is indeed very convenient.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image access device with a wireless transmission function, comprising at least:
a scan unit being used for scanning a to-be-scanned document and outputting a scan image accordingly;
a control unit being used for receiving a signal, which initiates a wireless scan function, to control the scan unit to scan the to-be-scanned document accordingly; and
a first wireless transmission unit being used for receiving the scan image and transmitting the scan image to a portable electronic device in a wireless transmission way.

2. The image access device according to claim 1, wherein the control unit is used for receiving the computer-output signal which initiates the wireless scan function.

3. The image access device according to claim 1, wherein the image access device further comprises:
a wireless scan operation unit being used for being triggered to output the signal to the control unit and accordingly initiate the wireless scan function.

4. The image access device according to claim 3, wherein the wireless scan operation unit is a touch panel.

5. The image access device according to claim 3, wherein the wireless scan operation unit is a hot key.

6. The image access device according to claim 1, wherein the portable electronic device comprises:
a second wireless transmission unit whose wireless transmission protocol is compatible with that of the first wireless transmission unit;
a memory unit being used for storing the scan image received by the second wireless transmission unit; and
a display unit being used for displaying the scan image stored in the memory unit.

7. The image access device according to claim 6, wherein the wireless transmission protocol of the first wireless transmission unit is 802.11a.

8. The image access device according to claim 6, wherein the wireless transmission protocol of the first wireless transmission unit is 802.11b.

9. The image access device according to claim 6, wherein the wireless transmission protocol of the first wireless transmission unit is 802.11g.

10. The image access device according to claim 6, wherein the wireless transmission protocol of the first wireless transmission unit is a Bluetooth wireless transmission protocol.

11. The image access device according to claim 1, wherein the portable electronic device is a personal digital assistant (PDA).

12. The image access device according to claim 1, wherein the portable electronic device is a mobile phone.

13. The image access device according to claim 1, wherein the image access device is a scanner.

14. The image access device according to claim 13, wherein the scan unit is a chassis.

15. An image access device with a wireless transmission function comprising:
a scan unit being used for scanning a to-be-scanned document and outputting a scan image accordingly;
a wireless scan operation unit being used for being triggered to output a signal which initiates the wireless scan function;
a control unit being used for receiving the signal which initiates wireless scan function to control the scan unit to scan the to-be-scanned document accordingly; and
a first wireless transmission unit being used for receive the scan image and transmitting the scan image to a portable electronic device in a wireless transmission way.

16. The image access device according to claim 15, wherein the portable electronic device comprises:
a second wireless transmission unit whose wireless transmission protocol is compatible with that of the first wireless transmission unit;
a memory unit being used for storing the scan image received by the second wireless transmission unit; and
a display unit being used for displaying the scan image stored in the memory unit.

17. The image access device according to claim 15, wherein the wireless scan operation unit is a touch panel.

18. The image access device according to claim 15, wherein the wireless scan operation unit is a hot key.

19. The image access device according to claim 15, wherein the portable electronic device is a PDA.

20. An image access device with a wireless transmission function comprising:
a scan unit being used for scanning a to-be-scanned document and outputting a scan image accordingly;
a control unit being used for receiving a signal which initiates wireless scan function output by a computer to control the scan unit to scan the to-be-scanned document accordingly; and
a first wireless transmission unit being used for receiving the scan image and transmitting the scan image to a portable electronic device.

21. The image access device according to claim 20, wherein the portable electronic device comprises:
a second wireless transmission unit whose wireless transmission protocol is compatible with that of the first wireless transmission unit;
a memory unit being used for storing the scan image received by the second wireless transmission unit; and
a display unit being used for displaying the scan image stored in the memory unit.

22. The image access device according to claim 20, wherein the portable electronic device is a PDA.
